(19) United States
(12) Patent Application Publication
(10) Pub. No.: US 2019/0177895 A1
(43) Pub. Date: Jun. 13, 2019

(54) Laser Abrasion Methods to Eliminate Hand Sanding, Double Laser Marking, PP Spray and Garments Produced Thereof

(71) Applicant: RevoLaze LLC, Westlake, OH (US)

(72) Inventors: Affan Ur Rahim, Westlake, OH (US); Darryl Costin, JR., Westlake, OH (US); Heath Colwell, Sheffield Lake, OH (US)

(21) Appl. No.: 16/155,203

(22) Filed: Oct. 9, 2018

Related U.S. Application Data
(60) Provisional application No. 62/622,045, filed on Jan. 25, 2018.
(60) Provisional application No. 62/570,487, filed on Oct. 10, 2017.

(51) Int. Cl. D06B 11/00; D06M 10/00; G06T 11/00; G05B 19/418

(52) U.S. Cl. CPC D06B 11/0096; D06M 10/005; G05B 2219/32177; G05B 19/41875; G06T 11/001

(57) ABSTRACT

Laser files are modified to create light version files by adjusting the levels of the files.

This application claims priority from provisional application No. 62570487, filed Oct. 10, 2017; and from provisional application No. 62622045, Jan. 25, 2018; the entire contents of both of which are herewith incorporated by reference.

### BACKGROUND

For decades the fashion industry has included varying degrees of intentional destruction as a means to add detail and character to garments. Not surprisingly, the processes of making a garment seem like it had experienced a surplus of labor intensive time is in fact labor intensive, and is also environmentally demanding as it requires the use of machinery, energy, water, and harsh chemicals. This destruction is commonplace on several garment types, but pants receive an inordinate amount of this attention. This destruction process has many forms. One of the common early practices called for the use of sandblast equipment. This process was deemed hazardous, bringing the operators to harm from a disabling and often fatal lung disease called silicosis. Sand blasting was subsequently banned. One competing process was generally referred to as “hand sanding” which is when a laborer uses sand paper and manually abrades or distresses the garments with varying levels of abrasive material and pressure to create worn looks. Hand sanding is a more precise way to create worn patterns, as opposed to inarticulate broadcast of abrasion medium. The precision in design comes at the cost of repetitive injuries of the laborers tasked with maintaining high speeds with high pressure, stressing joints at the elbow, wrist, and fingers. A second alternative to sand blasting is laser abrading. At the time, RevoLaze introduced a safe, fast, repeatable alternative involving laser technology. The lasers have been deployed and used to vaporize the dye from the garments, most often denim jeans.

RevoLaze, the current applicant, introduced the idea of carefully controlling the power of the laser to precisely and consistently provide the results designers wanted and the efficiency the production teams required.

At the time of this writing, lasers are a much more widely accepted means of performing this labor intensive process.

Laser processed jeans are often criticized for appearing flat when compared to naturally worn or hand sanded jeans. A perceived flatness can be described as a wear pattern lacking salt and pepper, or highs and lows in tonal characteristics, as well as a lack of smooth feathering. Feathering is a characteristic seen on a garment where it transitions from an area without abrasion, to an area with abrasion. When that transition is abrupt, with no feathering, it appears to be pasted on rather than naturally worn in. To overcome the issue of a flat appearance, garment finishers using lasers to distress garments within the industry have typically had to hand sand after laser abrading to help achieve the necessary look. Having to hand sand after lasing adds additional steps and costs to the manufacturing process. Another means to achieve the highs and lows, which overcome the issue of flat appearance is to laser etch an abrasion pattern multiple times, in whole or in part. This can be known as double marking or multi layer processing of laser files. It has also been the exclusive method in which lasers could produce a 3D look, with more dimension and contrast within a pattern. The 3D effect on a garment is seen when an area of a garment consists of natural looking abrasion consisting of no abrasion, light abrasion, medium abrasion, and high levels of abrasion within an immediate vicinity. Traditional methods of drawing would require a pattern to be processed with low and medium abrasion levels, followed by a second or possibly a third layer to produce the higher and highest levels of abrasion. The 3D look has not been achievable using the single layer laser files etching the front or back of the jean with conventional laser files. Therefore, a section of the jean may have the normal laser design and an additional layer or file to emphasize certain parts of the design. This of course also adds cost to the jean manufacturing process.

Today's fashion trend often involves patterns that are brighter than have been achievable via the conventional means of hand sanding or laser processing. The brightness sought after by many designers involves the use of potassium permanganate (PP) spray to provide a bleach appearance in areas specifically sprayed with PP spray. This bleaching effect specifically targets the areas processed with hand sanding and laser abrasion. The PP spray amplifies the effect of either process, creating a much brighter abrasion aesthetic of an otherwise similar process and pattern. In addition to varying patterns, dyes, wash routines, and textile types, the addition of potassium permanganate as a dry process for whitening patterns created significant environmental and health issues due to the toxicity of the chemical. Shortened to “PP spray” potassium permanganate offered designers the option to get excellent contrast properties between their pattern and the base color of the textile. This base color, the color of the areas unaffected by abrasion, is often referred to as the cast. PP spray, while offering design options, brings with it threats to the kidneys, liver, and lungs. Since sustainability and the environment are starting to play very important roles in the denim industry, all brands and manufacturers are looking to replace PP spray without comprising the desired look.

### SUMMARY OF INVENTION

The inventors realized the need to invent new laser methods that could provide the laser abrasion with the necessary highs and lows to simulate the worn look and at the same time eliminate: 1). hand sanding touch ups after the laser abrasion and/or 2). multi layer laser files and/or 3). PP spray. The authors further felt it would be a significant advancement if they could invent a process to automate the laser file creation process.

The authors have invented novel laser methods that generate a laser abrasion pattern on denim with more detail than the conventional laser method of creating or drawing the graphic pattern, and surprisingly allows for the elimination of one or more of the following costly processes: hand sanding, multi layer laser files and PP spray typically used to create the authentic worn look. The authors have further invented a process to automate the file modification process.

This is done by obtaining a laser abrasion pattern as a file that represents a pattern of abrasion to be lazed on a textile, where larger numbers on the grayscale chart represent lighter colors, and smaller numbers on the grayscale chart represent darker colors to be processed by the laser, and modifying the pattern, to create a darker and more heavily lazed sections of the pattern at color levels ranging from between 80-120 on the 256 level color gray scale chart, and feathering the abrasion intensity from the intense darker sections to lower intensity sections using color levels ranging from 179 to 230 (70% to 90%) on the 256 level color gray scale chart.

### BRIEF DESCRIPTION OF THE DRAWINGS

In the Drawings:

FIG. 1 shows an example of grayscale color range used to create the patterns on the denim.

FIG. 2A shows the normal laser file created with the higher color values shown and the subsequent denim after lasing such file.

FIG. 2B shows the result of lasing using these techniques.

FIGS. 3A-3B shows the Light Version laser file created with the lower color values shown as in an embodiment, in FIG. 3A, and the subsequent denim after lasing such file from the unique methods disclosed in this invention in FIG. 3B.

FIG. 4 Shows examples of multiple laser file scenarios. The Left most example is a single layer, high intensity file processed conventionally. The Middle file is an example of 2 file processing where a second file enhances the appearance of an image by repeating the laser process in select areas of the pattern to increase dye removal or further deteriorate the denim integrity selectively. The pattern on the right demonstrates the disclosed invention, utilizing the novel concept of altering the image file and laser operating system parameters to simulate the benefits of a 2 file process with a single file, single pass.

FIG. 5A An image depicting the default curves window as it appears when opened

FIG. 5B An image depicting the curves window when being adjusted as described in order to lighten the image

FIG. 6A is an example of a base or first file used in a 2 file, 2 pass scenario.

FIG. 6B is an example of a second file, or second pass file used in a 2 file, 2 pass scenario. As is commonplace, the second file is composed of a partial or edited copy of the first layer (6A);

FIG. 7 is a flowchart detailing an example of the operations conducted to attain the result that is the disclosed invention.

FIG. 8 Is an example of a Light Version laser file and laser etching time is shown;

FIG. 9 is another example of a Light Version file compared to a traditional, or dark version file;

FIG. 10 shows different washed down ranges of indigo color for denim;

FIG. 11 shows the range of different tones that can be obtained;

FIG. 12 shows how it is now possible to achieve 3D type looks and optical illusions;

FIG. 13 shows how this disclosed technique is applied to different finishes, including a dark wash medium wash and light wash (wash resulting in darker material, medium colored material, or lightly colored material);

FIG. 14 Demonstrates how a user can use the “handles” within an image processing software package such as Photoshop, or one similar, and by moving the handles that would normally default to 0 or 255 to the left will result in the image getting lighter throughout some, all, or most of an image, depending on the original tones within the image.

FIG. 15 is an example of a dark single file with a displayed histogram.

FIG. 16 is an example of the output from the LightLaze process with the file from FIG. 15.

FIG. 17 is an example of a base file of a conventionally drawn, dark two file process.

FIG. 18 is an example of a second file of a conventionally drawn, dark two file process.

FIG. 19 is an example of the LightLaze process output with the files from FIG. 17 and FIG. 18.

FIG. 20 is an example of a preview screen for a prototype of the LightLaze process. The layout and information displayed could be changed partially or completely, but the depicted ease of use within the image serves as a critical embodiment of the invention.

FIG. 21 is an example of FIG. 20 after a user has loaded two files, a base file, and a secondary file that would be conventionally used for processing and showing how upon pressing the “preview” button, the invention displays the base file on the left for basis of comparison, and the LightLaze output on the right.

FIG. 22 is an example of an output file from FIG. 21. From this screen the user could easily save the output image to their local computer or network for further image processing or laser processing.

FIG. 23 is an example of DPI, providing a pictorial representation of the significance of DPI on the quality or fineness of detail within image

### DETAILED DESCRIPTION

In order to achieve the fine detail of the laser abraded pattern to simulate the hand sand or authentically worn look, the inventors found that the visual appearance of the denim should show various highs and lows within the pattern. These highs and lows could be throughout the design. There could be areas with darker colors adjacent to lighter colors, or darker colors adjacent to a white color for extreme contrast. These highs and lows could be pixels, lines, or other shapes throughout the design to achieve the necessary contrast.

Laser abrasion files consist of multiple areas on the garment for consideration. Generally these areas can be summed as whiskers, thigh abrasion, knee, chevrons, rear seat area, rear knee, and ankle area. Whiskers, chevrons, and some areas of the seat and thigh are typically the areas that receive the most abrasion. The grayscale 256 colors range is 0-255 color values where 0=black and 255=white, and a color value of 128 would be associated with the most medium grey.

When developing laser abrasion files for laser etching on the rigid garment, the conventional method to draw the laser designs typically involve use of the dark colors from 0-50 to be used for whiskers, chevrons, and the more intense areas of the seat and thigh abrasion. Areas that were intended to be abraded less would involve colors ranging from 51 to 220, or a light grey. Working with this conventional and intuitive coloring scheme, colors lighter than 220 are typically ignored and considered unnecessarily light. So much so that a function was added to the software of large equipment manufacturer's software to serve this exact purpose, and the default value for their threshold color is 220. This means that the colors valued at 221-255 were ignored by the system both by the power controller, as well as the mirror steering mechanism. This was done as a result of the thoroughness of the adopted conventional method where power and speed were set at their highest respective points, and typically at such high speeds, even at full power, colors of 221 and higher would result in a non-lased appearance. A power insufficient enough to remove dyes would create such an appearance. Areas that were intended to stand out to present the 3D effect are processed a second or even a third time, again with color values often as dark as 0-50 being the primary purpose of the additional layer(s). The additional layers could be processed with color values higher than 0-50, but conventional wisdom would suggest this inefficient, and therefore uncommon. Each successive processed layer requires additional time, proving effective at highlighting areas, but inefficient. Each of these layers is processed at a speed whether denoted as mm/s, m/s, or pixel time. Conventional method of approach and application involved choosing a speed that best suited to the feathering and medium intensity areas of the thigh abrasion, and then a typical operator would add layer(s) to the pattern to increase the abrasion to areas that required it. However, some of the values above can change depending upon the type of laser, type of denim used, wet processing formula, jean aesthetic and other factors.

An embodiment of the invention is make all colors of the image lighter than conventional methods, where the darkest color value may be as high as 50, and the lightest of values may be as light as 254, requiring the color threshold to be raised accordingly. These files would be processed at a slower rate to compensate for the lack of power output from the laser due to the lighter colors. The files are drawing substantially lighter results in a lased image with improved apparent detail and depth. Inventors believe at the time of writing that the drawing with colors purposefully lighter than conventional practice and wisdom suggest, results in the exploitation of a lack in linearity of power on the laser's part. The embodied method of drawing seems to afford the artist an increased level of detail within the used color palette. The slower processing of a single file provides significant time savings over the faster processing of multiple files. However, all colors of the image can be lighter without adjusting the color threshold.

Another embodiment of the invention is to retain the use of color values from 0-50, but doing so as to create intensities only previously capable with a second or third layer. These files would be processed at a slower rate than files would be traditionally. The balance of the file would be drawn in a way that would be considered disproportionately light when compared to conventional drawing methods, and would require the user to raise the color threshold to 254. However, the color threshold does not always have to change from the normal settings. Conventional methods of drawing would involve many areas to transition in small predictable increments. This embodiment employs a method where the darkest colors represent brightly highlighted areas on a garment, but rather than small increments surrounding these dark colors, a much steeper change in color is used. The purpose and intent is such that while the laser is processing much slower in order to achieve the high intensities that previously required a second and third layer, all the while maintaining nearly identical power levels for the medium and low impact areas of the patterns. Files drawn using this method would result in unsuccessful results if processed conventionally, where the high intensity areas would be lacking the brightness traditionally produced by the second and third pass, and the low intensity areas would be either too light, or completely ignored by the laser due to conventional settings for color threshold. The slower processing of a single file provides significant time savings over the faster processing of multiple files.

FIG. 1A shows a system of using a laser to abrade textile material, such as denim material, to form abrasion patterns on the denim material. FIG. 1B shows an example of grayscale color range used to create the patterns on the denim.

While laser etching process on denim fabric, No. 0 color value is the darkest color, which corresponds to the highest intensity of the laser.

The inventors designed laser graphic files in a totally unique way compared to the conventional method in order to get the detail and resolution to generate the appropriate look on the washed garment. To achieve the required pixel highs and lows in the design and eliminate any need of hand sanding touch ups and/or multi layer laser files and/or to get the necessary brightness where PP spray is not needed, the inventors decided to go against normal teachings and use much lighter overall colors throughout the file design process as one embodiment. So, for example, the laser pattern may start with medium to light colors around 80-120 (31% of the 256 level chart to 47% of the chart) and then feather out to even lighter colors around 200-230 (78% to 90%) on the 256 color grayscale chart to get the appropriate look which is an embodiment. This also allows much higher detailed designs and textures, and better replications of authentic worn looks. This novel technique is referred to herein as “Light Version”. However, depending upon the fabric, wash and standard, these values can change.

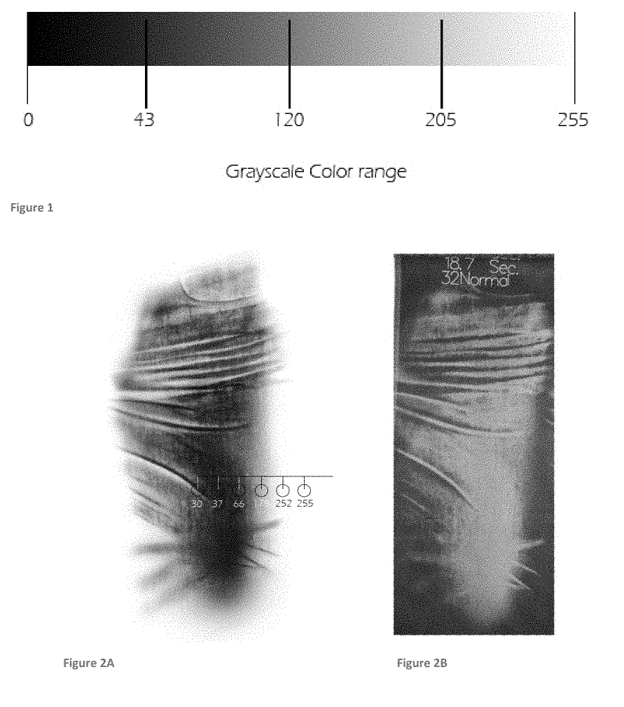

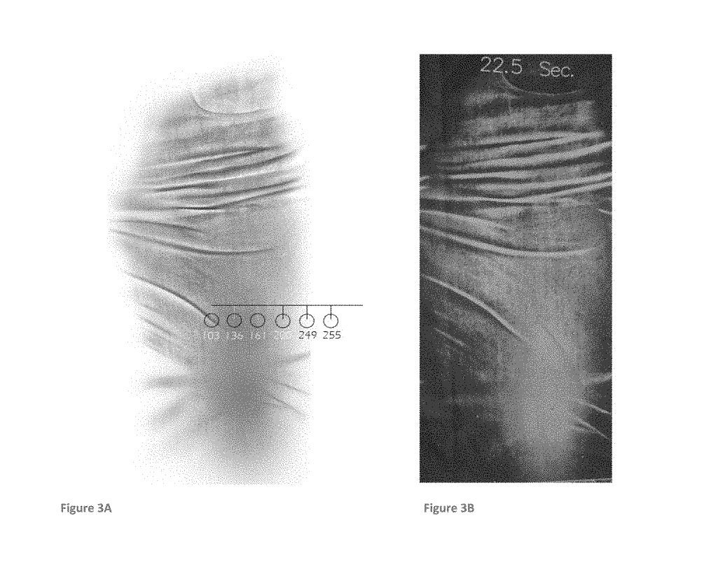

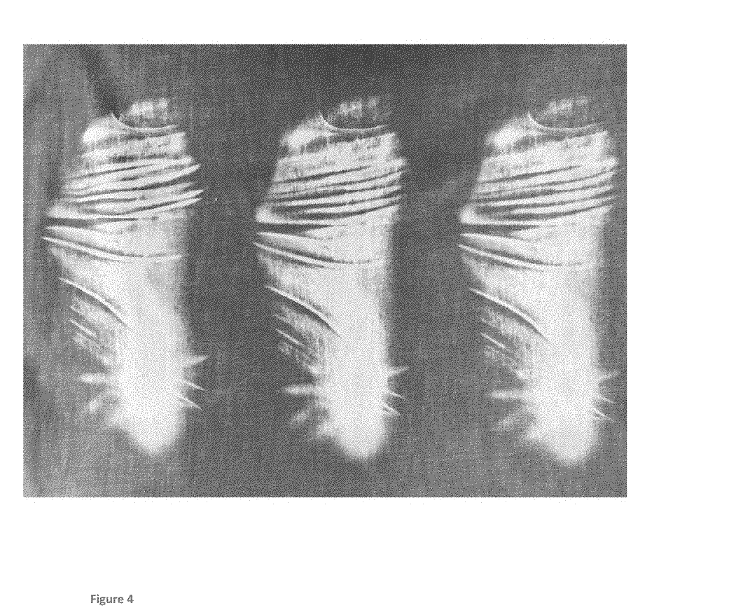

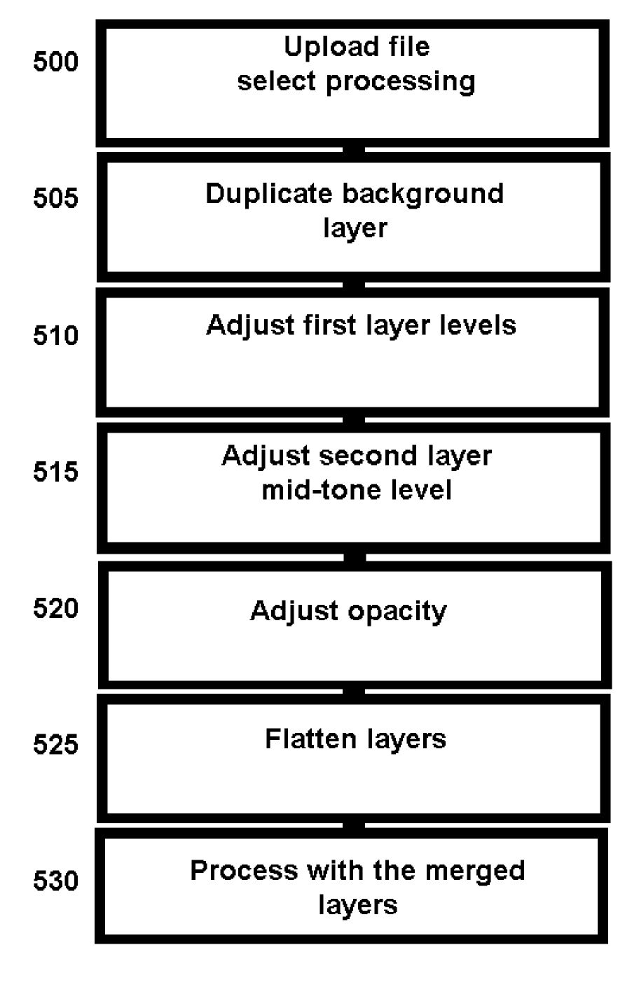

FIGS. 2A-2B demonstrates the Light Version reduced color values necessary on the 256 color grayscale chart to get the necessary affect. As explained above, an embodiment describes using lower color values (higher numbers on the color grayscale chart) versus those used in the standard graphic laser abrasion pattern design to create the desired look with highs and lows that replicates the authentic worn look. Trials have shown that Light Version color values for the high intensity portion of the graphic (where the start in the color grayscale is usually in the center of the pattern) can be only a fraction of the color values used for conventional methods, for example going from a range of 0-20 for conventional to 60-120 for Light Version which is an embodiment. In a similar way, for the feathering graphic or lower intensity portions (usually along the edges of the pattern) the color values for Light Version can be significantly reduced from the color values used in the normal prior art graphic techniques, for example going from 200-230 to 180-220. Such reductions in the color values are embodiments. The results employing this novel concept were quite surprising as revealed in the pictures of FIGS. 2A-2B.

FIG. 2A shows the normal laser file created with the higher color values shown and the subsequent denim after lasing such file. The flatness of the denim is prominent and the inventors believe this is the reason why these types of files need hand sanding touch ups or lazing multiple layer files. The color values used in the laser file creation are shown in the line diagram superimposed on the picture.

FIG. 2B shows the result of lasing using these techniques.

FIGS. 3A-3B shows the Light Version laser file created with the lower color values shown as in an embodiment, in FIG. 3A, and the subsequent denim after lasing such file from the unique methods disclosed in this invention in FIG. 3B. The denim picture is quite revealing and unexpected in that the flatness has been replaced with more graphic highs and lows. This technique may not require hand sanding and/or multiple laser files to get the highs and lows because the unique laser file created with Light Version generates the necessary highs and lows. Additional changes to the file can be made to get more or less contrast. This type of method in addition to replacing multi layer files, can replace hand sand touch ups, which are embodiments. However, upon trying to match the standard, additional inventive methods may be required to replicate the look achieved from PP spray.

The comparison between the two examples illustrate the embodiment of this invention using totally different range of color values.

The processed patterns in FIG. 4 clearly illustrate how methods disclosed in this invention can replace multiple laser files. The far right picture shows the one layer file lased on denim. The appearance of the design is flat without the highs and lows required to simulate the authentic worn look. The middle picture shows more contrast with the required highs and lows and was produced from multi laser files. The far left picture also shows good contrast with the required highs and lows but was surprisingly made with one laser layer with the Light Version techniques disclosed in this invention.

There are several ways to convert normal laser files to Light Version laser files in Photoshop or other graphic software, some of which are shown in the example methods below and represent embodiments of this invention.

Once an image is flattened, or the image has all or multiple layers merged to one layer, a number of different techniques could be used to lighten the layers to use the techniques of the present application. Each of these techniques define different embodiments of how to lighten the layer.

### Embodiment 1

Input Levels Adjustment

On the “Image” pull-down menu we choose the “Adjustments” sub-menu and select “Levels.”

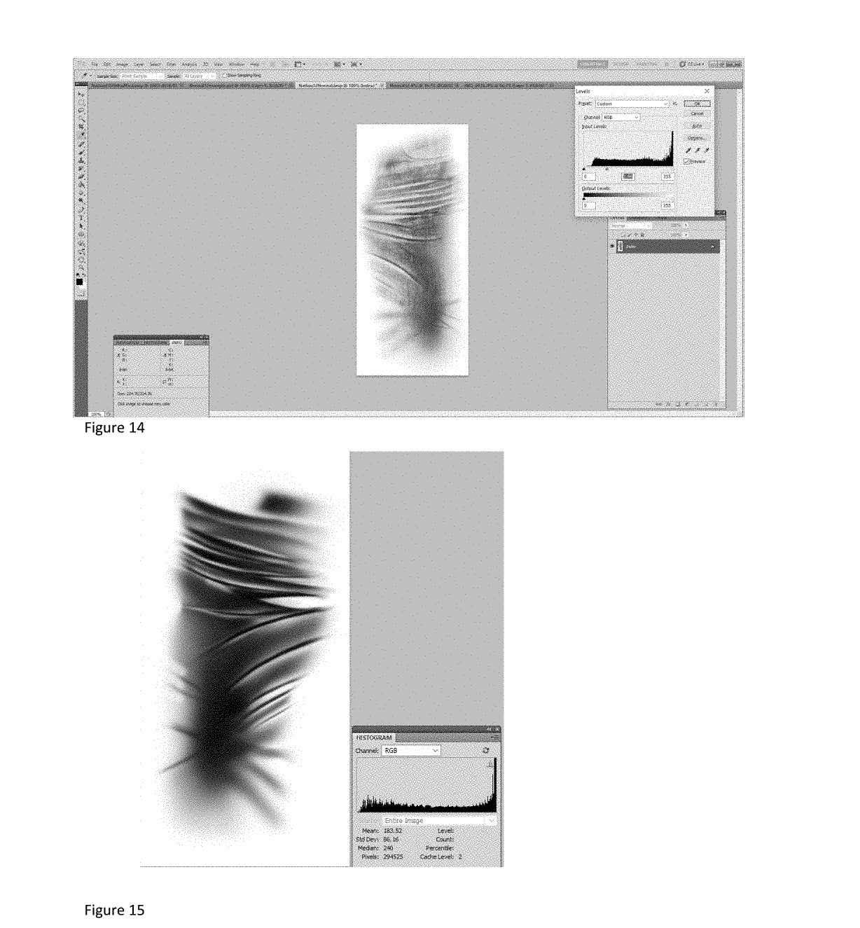

Sliding the handles for mid and lighter tones (0 and 255 default values) to the left as shown in FIG. 14 will lighten the image to make Light Version file.

Method 2

Output Level Adjustment

On the “Image” pull-down menu we choose the “Adjustments” sub-menu and select “Levels.”

Increase values in the Output Levels in Levels Dialog box. Here the output level is changed from 0-256 to 71-256. More generally, the bottom most number is set to a value around ⅓ of the way up the usual scale.

Method 3

Curve Adjustment

Levels

On the “Image” pull-down menu we choose the “Adjustments” sub-menu and select “Curves.”

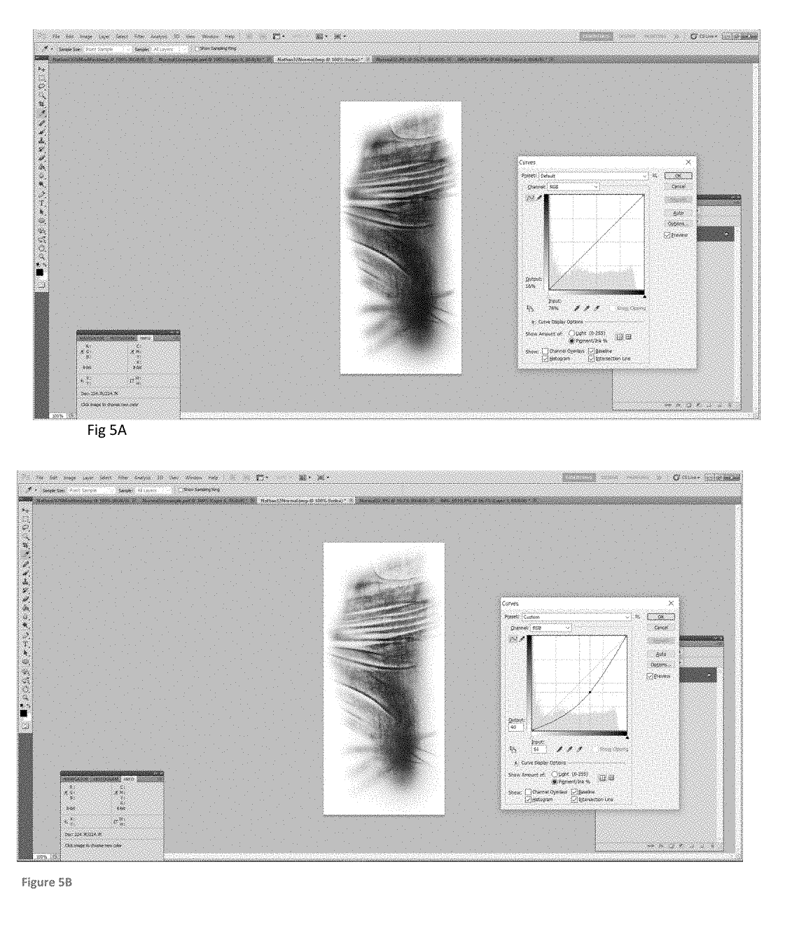

Drag the middle of the diagonal graph line downwards to generally lighten image. More generally, the curve between input and output is made non-linear, as shown by the comparison of FIG. 5A to 5B. An alternative way of carrying out this embodiment is to use the Curves Dialogue box, select “Show Amount” of “LIGHT” (0-255) and select starting point of diagonal line and raise upwards toward the number 80. This will generally lighten the image.

Method 4

Exposure

Using the “Image” pull down menu, we choose the sub-menu “Adjustments” and select “Exposure”

In Exposure Dialogue Box

1. Increase Exposure value will make image lighter or

Increase Offset value will make image lighter or

Decrease Gamma Correction value will make image lighter.

Any of these embodiments can be used to lighten the image.

Method 5

Brightness/Contrast

On the “Image” pull-down menu we choose the “Adjustments” sub-menu and select “Brightness and Contrast.”

In Brightness/Contrast Dialogue Box

Increase Brightness value will lighten the image

Decrease Contrast value and increase Brightness value will lighten the image

Method 6

Shadows/Highlights

Go to ⇒Image -->Adjustments→Shadows/Highlights.

In Shadows/Highlights dialogue box

Increase values of Shadows will lighten the image.

Method 7

HDR Toning

Go to ⇒Image -->Adjustments →HDR Toning.

After Flattening image

In HDR Toning Dialogue box

Decrease Gamma value will lighten the image or

Increase exposure value will lighten the image or

Increase Highlight value will lighten the image or

Increase diagonal bar in the Toning Curve and Histogram graph towards up as per the image will lighten the image

Method 8

By changing layer opacity on white or background layer will change the brightness of the image.

Method 9

By adding a white opaque layer on top of a normal image and by reducing opacity between 99 and 1% of white layerwill also lighten the image.

The authors desired to invent a method to convert automatically laser files into Light Version files. This would eliminate the considerable training that would be required to teach the laser technicians the steps detailed above and would substantially increase productivity by eliminating hours of file modification time. The examples above only lighten the images. To truly convert files to a format which is optimized for Light Version, additional steps are recommended to get the right look. So the first requirement is to detail the steps to manually convert the files. Two different embodiments are described herein.

A first case shown below is for the conversion of single files to Light Version files.

A second case shown below is for the conversion of two layer or multiple files to a single Light Version file.

In both cases, this can be done as individual steps, or automated via a macro.

Embodiment 1: Steps for Conversion of Single File to Light Version File

The user uploads one file, and the computer optimizes the file as per the process below.

The user uploads the first file at 500 and clicks for processing. The file is opened in an image processing program such as Photoshop.

At 505 the background layer is duplicated. However, in this embodiment a macro or program can do this step and each successive steps automatically.

At 510 the “levels” of the image are adjusted. In Photoshop, we select the second layer by choosing the “Image” pull-down menu, then choosing the “Adjustments” sub-menu and then selecting “Levels”. Ideally the default 255 input level is changed to 170, but could be changed within a range of 150-.

At 515, the first Layer is selected and its mid-tone input level is increased. Following the previous menu process for levels, we change the default 1.00 input level to ideally 1.50, but could be changed within a range from 1.20 to 1.80.

At 520, the opacity is adjusted. In Photoshop, this is done by changing the blending mode of the second layer to “Darken”. “Darken” or “blending mode” could be a different function name within different software programs but the invention is a function that performs similarly. Darken is the blending mode used for this example, but a similarly functional algorithm such as multiply, color burn, linear burn, screen, overlay, softlight, hardlight, vividlight, pinlight, or luminosity can be used.

Opacity will ideally be 85% but may be in a range from 60-90%.

At 530, the image is flattened.

Embodiment 2: Steps for Conversion of Multi-File to Light Version File

In the garment industry, lasers are used for abrasion (laser etch treatment) on denim garments, particularly to make whiskers (designs) and used area.

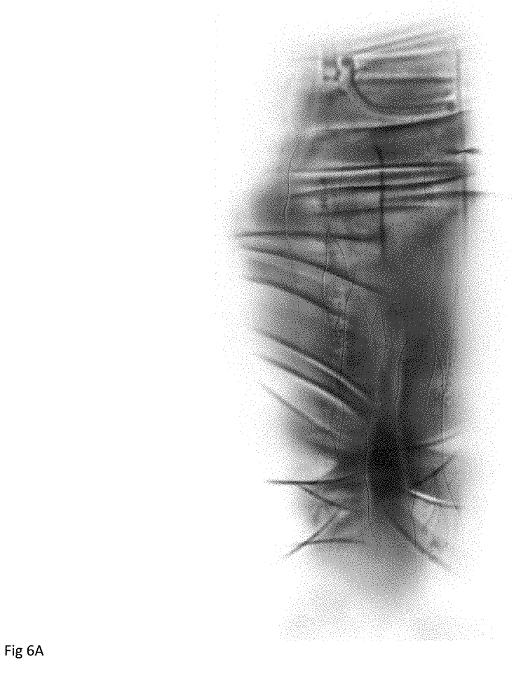

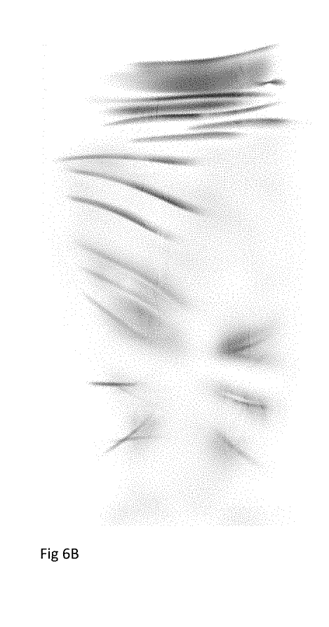

Single layer files processed traditionally can be enhanced through the use of a second layer, or a second pass with the laser. The second pass of the laser is often conducted with the original file, or a modified version of the original file, highlighting certain parts, such as whiskers. The embodiment demonstrates an original file in FIG. 6A and a partial copy of itself in FIG. 6B, to be processed successively. Adding the copy of the original with a reduction in energy intensity in a given area whether that be via a reduction in power or an increase in speed produces a desirable result, particularly in the darker of the areas. This adds depth, dimension to the pattern with the increased disparity between the lightest of light areas, and the darkest areas.

While marking with multiple passes achieves desirable levels of detail and depth to the pattern, it does so at the expense of machine efficiency. The laser passing over the file a second time can double the cycle time of the machine, resulting in increased costs and decreased throughput. The reduction in throughput and is often enough to make laser processing either less viable or impossible due to quantities ordered, shipping requirements, and the additional burden of time put upon machinery. This limits lasers to shorter production runs of premium patterns as a result of throughput concerns.

The embodied Light Version method is the result of much testing through the thousands of Photoshop tools. The implementation of the embodied method allow a user to achieve the results formerly only capable with multiple file multiple pass production, with a single file, single pass, enhanced process. One example of such a Light Version file is shown in FIG. 6C.

Traditionally, laser patterns were created so that the laser could run at the highest speed possible. The color 0 would represent the darkest areas of the pattern, and a color value could be as high as 220 to represent the lightest area of the garment. The change in color values would often be gradual. Running at a high speed lowers the maximum amount of energy capable of hitting a given area, but makes the drawing process simpler as the gradient becomes relatively linear from relatively intense to very light energy. Areas of the garment that were receiving too little energy were either hand sanded or hit with an additional pass of the laser, typically in areas that called for increased energy. This second file, or second pass of the laser, created greater contrast in areas that called for it. Perhaps there was an edge of a whisker or a knee that required substantially greater energy than was possible with the traditional protocol of highest speed possible. This could result in a second, or even a third pass of the laser. The disclosed invention challenges this traditional method. A user can drawn conventionally and upload their second file. The combination of the two files highlights the areas that should receive greater amounts of energy in a single pass. The process of providing greater energy to a given area in a single pass involves slowing the laser speed, or decreasing pixel time. While this provides great benefit to the areas that require more energy intensity, many, if not most of the areas of the image were drawn appropriately for the desired output at a higher speed. The disclosed invention remaps the colors such that the drawing is optimized to provide a greater amount of energy with slower speeds, while raising color values (lighter colors) in the transitional medium and lighter tones to retain the ideal abrasion levels throughout the image at the slower speeds. The output from the Light Version process involves files that transition more quickly from 0 to 220 and have a greater usage rate of colors in the 180-220 range an increase in mean value in comparison histograms. Typically the files produced from the Light Version process appear to be lighter overall in color, hence the name.

Due to the lighter colors implemented in the majority of the file, the inventors believe that traditional laser parameters would produce unsatisfactory results. Processing files with the Light Version methodology require slower processing times (longer pixel times) to achieve enhanced results. But the slower processing of a single file provides significant time savings over the faster processing of multiple files.

When the user runs this file with normal parameters the result gets lighter, so the user will use higher pixeltime (lower speed or increase energy density in terms of laser language) to get the same result as in the case of a multiple files, but also save some time.

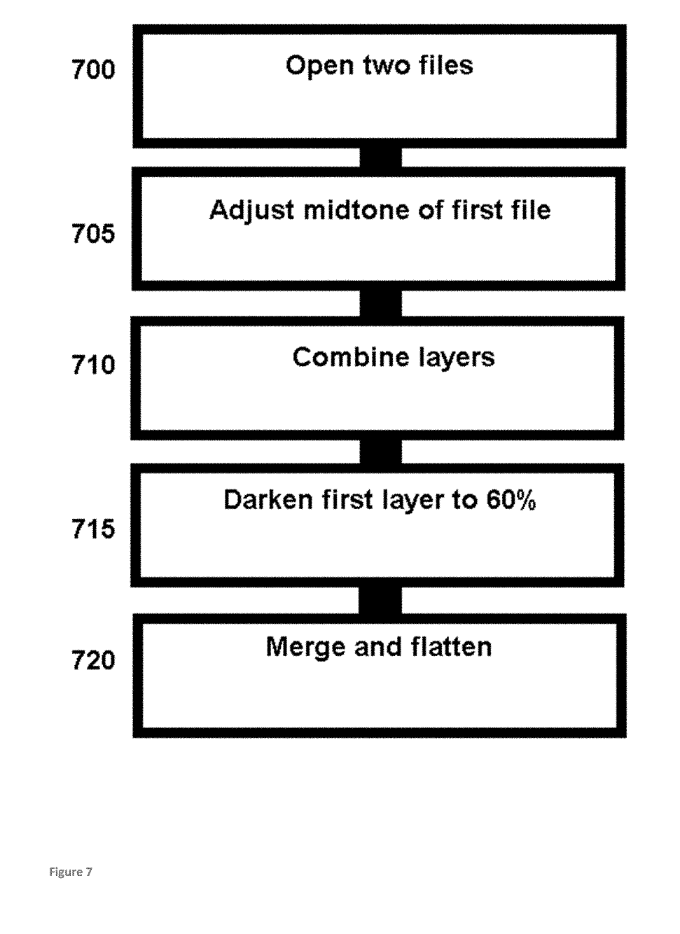

To convert those two files to one file, the inventive steps are shown below and represent embodiments. When the user will upload the files and click for processing. Below are actions to get optimized file output. This can be done with any image processing program, and can be done via a macro as outlined in the flowchart of FIG. 7.

At 700, first the user opens the first, or base file. Secondly, the user opens the second, or accent file.

At 705, the mid-tone is adjusted in levels. On the first file, go to levels menu as previously described and adjust mid-tone input level from default value 1.00 to 1.50 (1.5 is Ideal but could be a range of 1.2-1.9)

At 710, the two files are combined. This step involves combining the two files. This is one method of combining multiple images to create a single image with multiple layers, but other methods do not deviate outside of the invention. First, open the second file select all, copy and with the first file selected, paste the second file. This adds the second image as a second layer to the first image.

At 715, the second layer is darkened. Select second layer and specify the blending mode “Darken”. “Darken” is the layer type used for this example, but a similarly functional process, such as multiply, color burn, linear burn, screen, overlay, softlight, hardlight, vividlight, pinlight, or luminosity can be used.

Specify second layer opacity of 60% as shown below (60% is ideal but could be a range of 40-80%)=

At 720, the layers are flattened. After layers are merged or flattened and saved, this will be the final output of the image.

This disclosed invention can be used to create “Light Version” effects with conventionally drawn patterns. These Light Version effects create better results when drawn by a laser, as described herein.

A feature of the Light Version file comes when incorporating the second layer. When the second file, or accent file, has darker colors than a respective copy, the Light Version process rewards the user with greater contrast between the darker tones in the image relative to the medium and lighter tones within the image. This specification is important because if all the colors were just lightened, there would not be enough contrast within the file and it may require an additional pass with the laser to give the desired result. The second layer is used to darken certain areas within the file, such as the whiskers or knee area. Choosing “Darken” as the layer type, looks at the color information in each channel or layer and selects the base or blend color, whichever is darker, as the result color. That is what makes it replicate the look of a multi layer file. Other potential tools in Photoshop can be used, such as “Curves”, but the inventors found these steps to give the most consistent results.

The process of moving these cumbersome Photoshop steps into a software intereface can include additional functionality One example is a checkbox for “Enhancement”. If this option is checked then the system can change the Levels settings. Default value of 0 could be changed from 20-40 and mid-tone default value of 1.00 could be changed from 1.5-2.5.

So the final output with Enhancement exaggerates contrast further.

The methods illustrated are preferred embodiments of this invention, however, the shift in color values can be consistent throughout the grayscale range or disproportional. If you break up the grayscale colors into high tones, mid tones and low tones, the shift to lighter colors can be the same amongst all three tones or can be different. Another embodiment lowers some of the color values and raises some of the higher color values for more extreme contrast and effects. If the curve tool is used, a variety of different curved shapes can be applied to the design to achieve a variety of different effects.

Aged and worn denim jeans typically have creases on thigh area and/or on knee area. Over time with repeated wearing, these creases develop what are commonly referred to as whiskers or chevrons in the garment industry. Those whiskers can be varied, with combinations of different shades or shapes. Pattern designers replicate this wearing process by drawing whiskers and abrasion patterns. These shades vary as per the user develops the design. Patterns may be dark, light, medium, sharp, blurry, or uneven. These patterns may replicate authentically worn jeans, or jeans processed by other means such as hand sanding or even earlier designs that have been lasered These whiskers can be made by laser abrasion. The laser abrasion process etches these designs which are given input by the user in the laser machine. These designs are created generally in Photoshop software similar graphic editing software to replicate and develop the worn look by giving different shades of whiskers and abrasion patterns. While using these different shades, due to color gradation curves and laser tube marking capability, the laser machine cannot exactly create same depth of darkness across the span of potential intensities. Because of this limitation it is difficult to achieve desired effect by laser in one time marking which is called single layer. To remedy this situation, the user has to develop multiple layers in Photoshop. Thereafter the user imports those designs in laser machine software and marks them separately one file on top of the other. This technique may be considered multi-pass, multiple file, or multi layer. This technique provides a more authentic representation of the various characteristics involved in the worn look, at the expense of cycle time

As illustrated earlier, key embodiments eliminate the need for multiple laser files by creating the same effect with only single layer files. The three pictures side by side cited earlier demonstrate that Light Version files can indeed replace multi layer files.

The examples below are embodiments of this invention and disclose the process for the conversion of different intensity laser files to Light Version files.

FIG. 15 shows a dark File Color Range, including a Dark single file before process of Light Version process and its color ranges. The mean color in the histogram is 183.52. It is important to note that the histogram uses the white colors that surround the image in the calculation of the median color within the image. The actual mean value of the image that is being processed would typically be much lower in value, or darker in color.

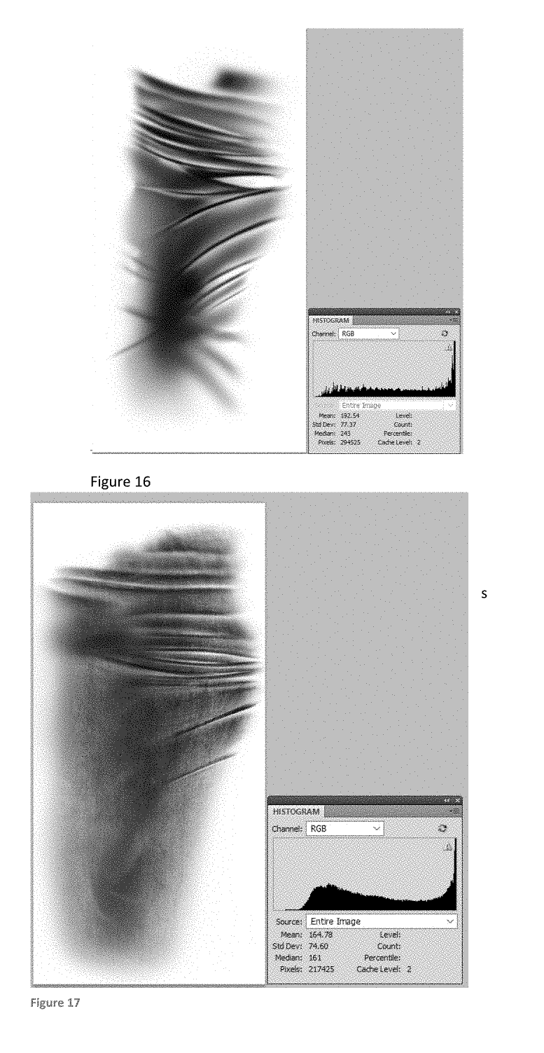

FIG. 16 shows an Output file from LightLaze processing. We can see that the mean value in the histogram has risen (lightened) to 192.154.

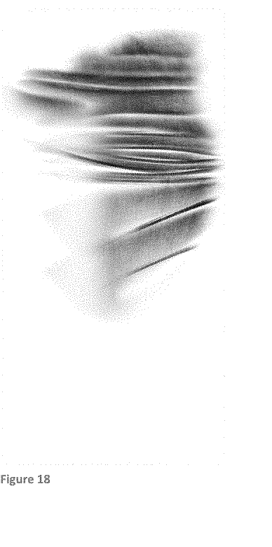

FIGS. 17 and 18 represent a multiple file process, with FIG. 17 as the base file and FIG. 18 is the second pass for select areas.

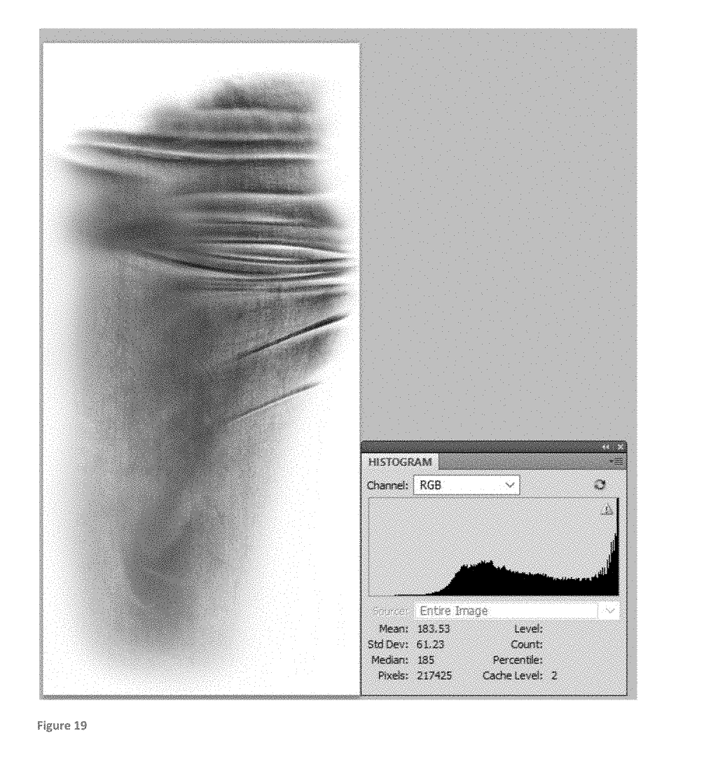

FIG. 19 is an example of single file output from two files input into LightLaze

An important embodiment of this invention is to combine all these steps into an automatic sequence for different intensity files, which output a Light Version file. An example of such automation not previously available anywhere is shown in the screen shots below of the RevoLaze prototype software system:

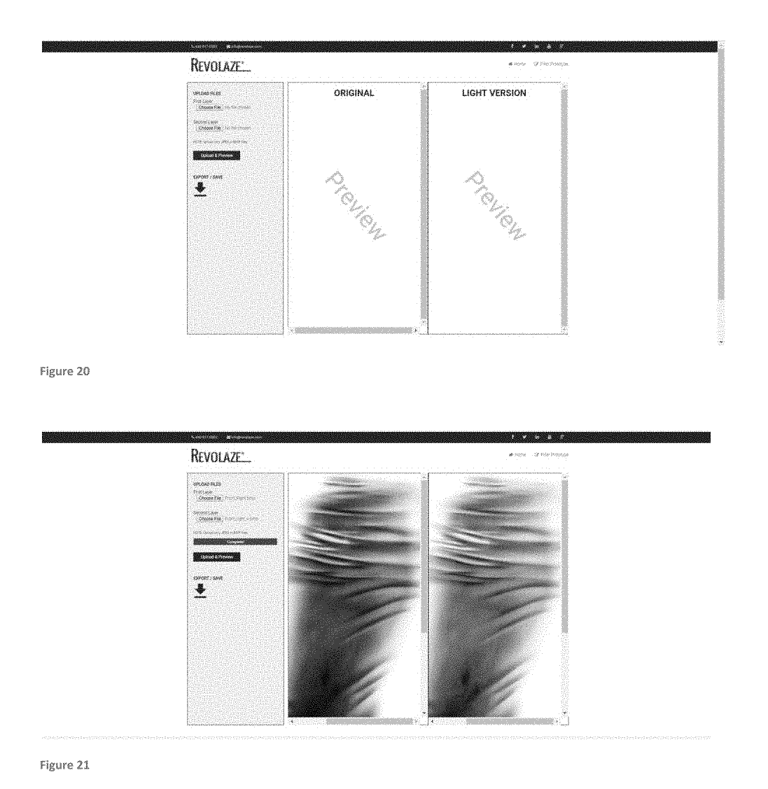

The Layout of the automation software when you open the website url is shown in FIG. 20.

When user uploads their original files in First Layer and Second Layer,

After uploading both files and click on “Upload and Preview”,

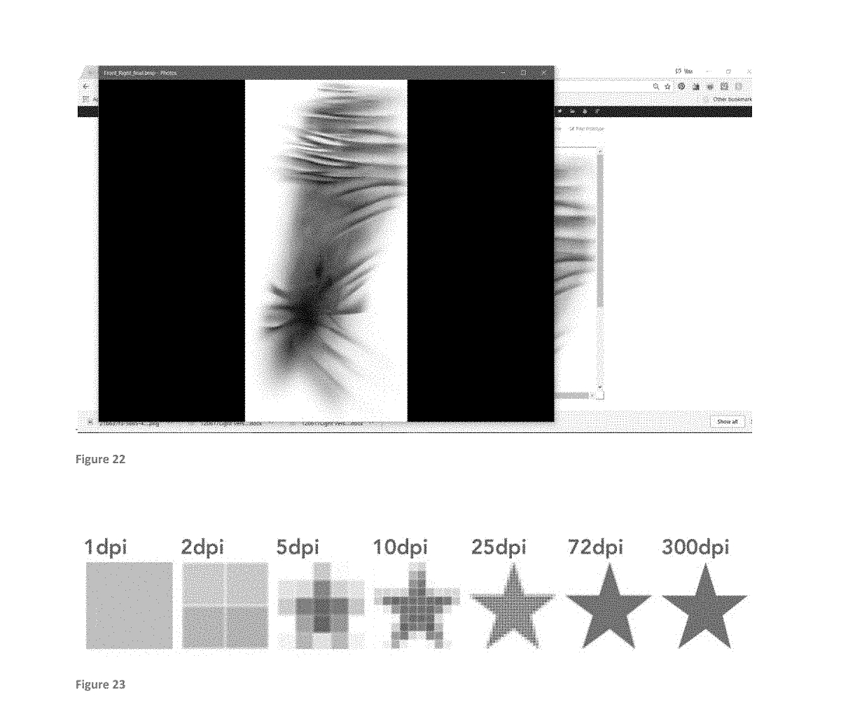

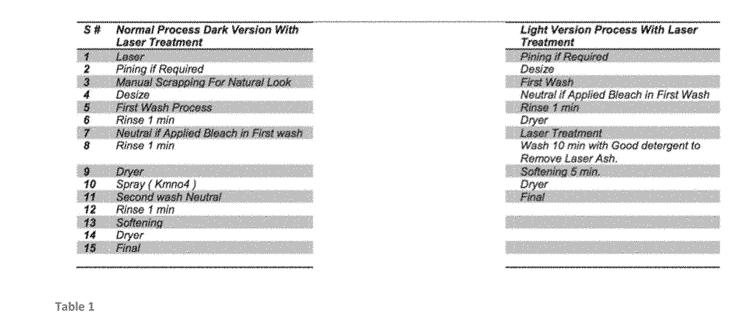

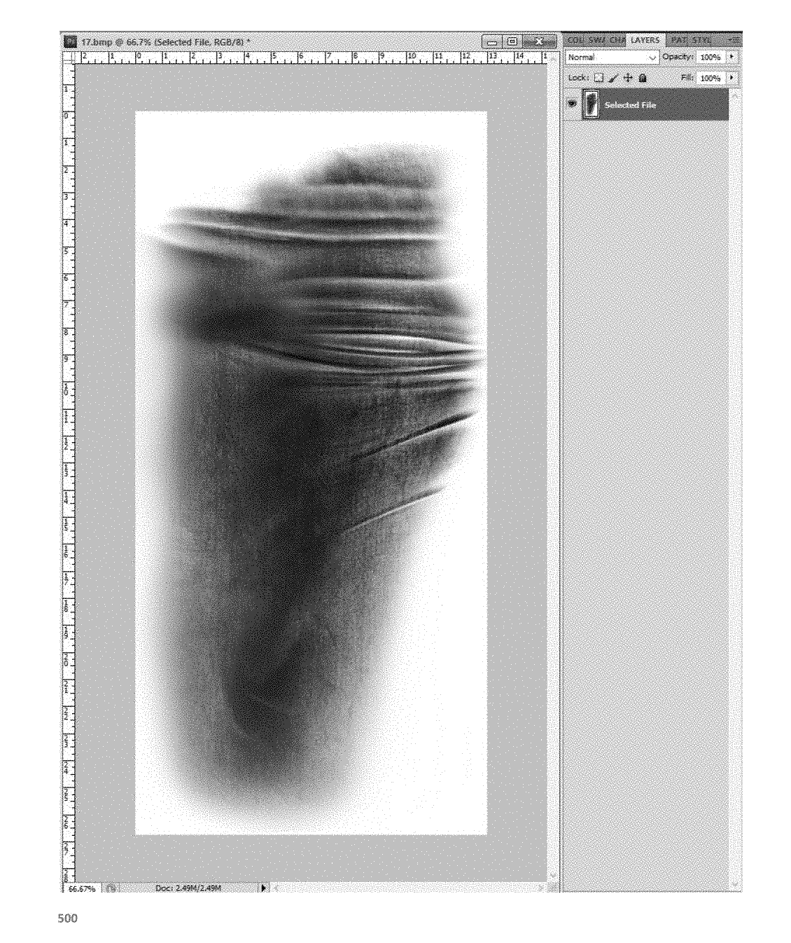

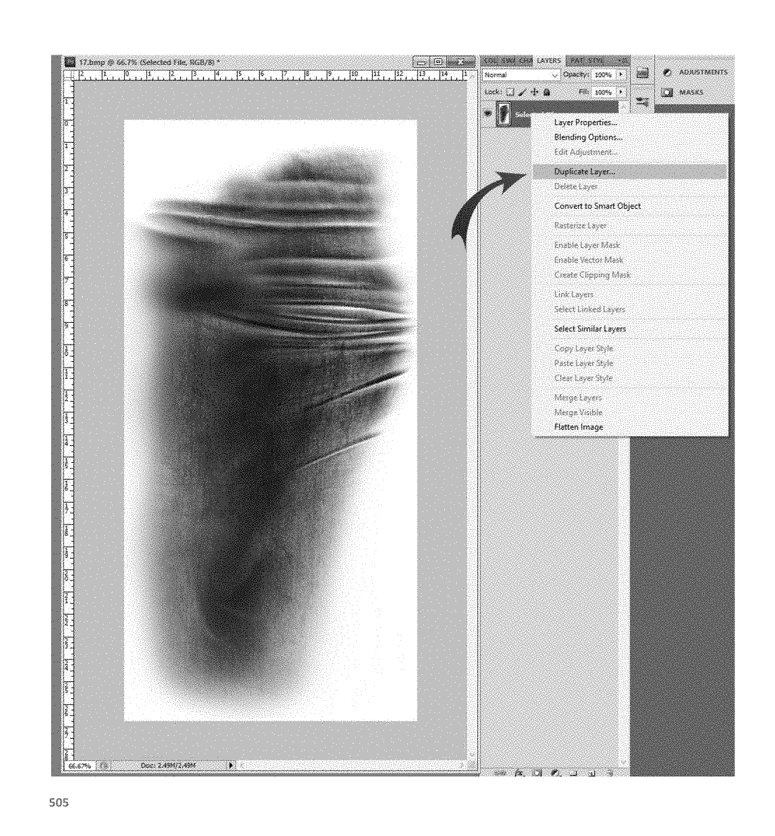

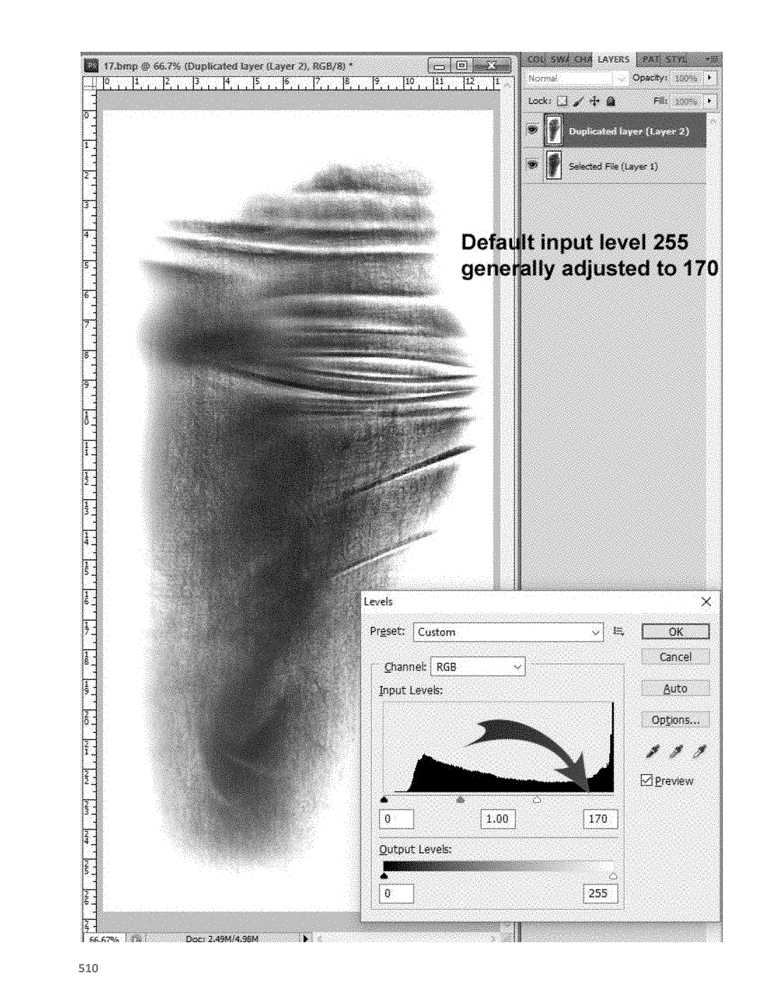

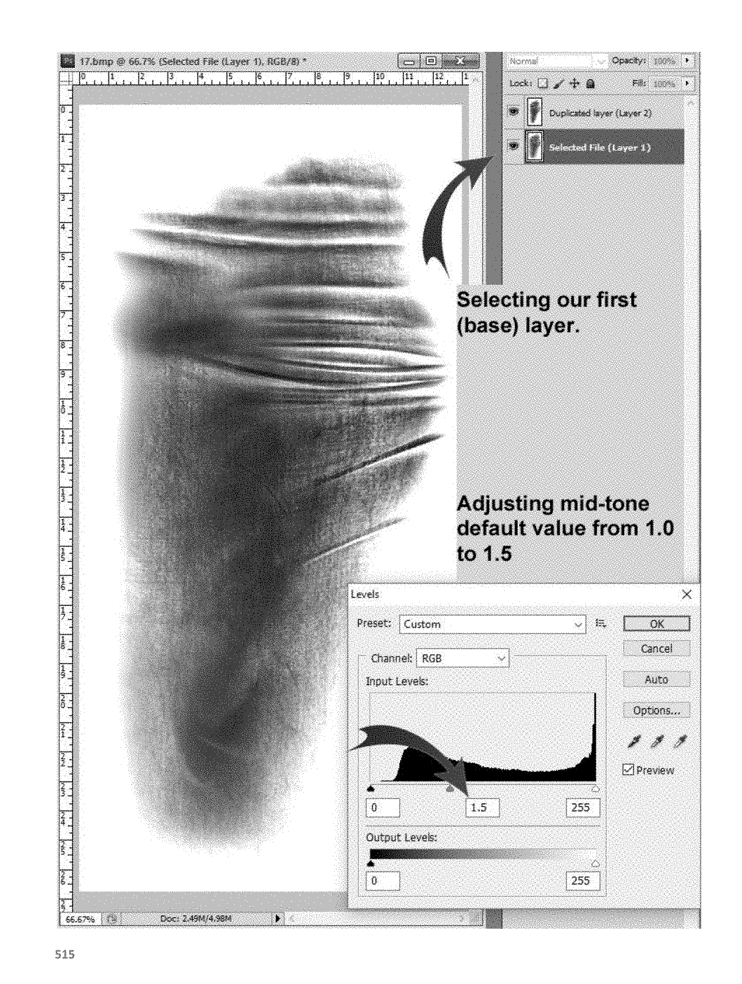

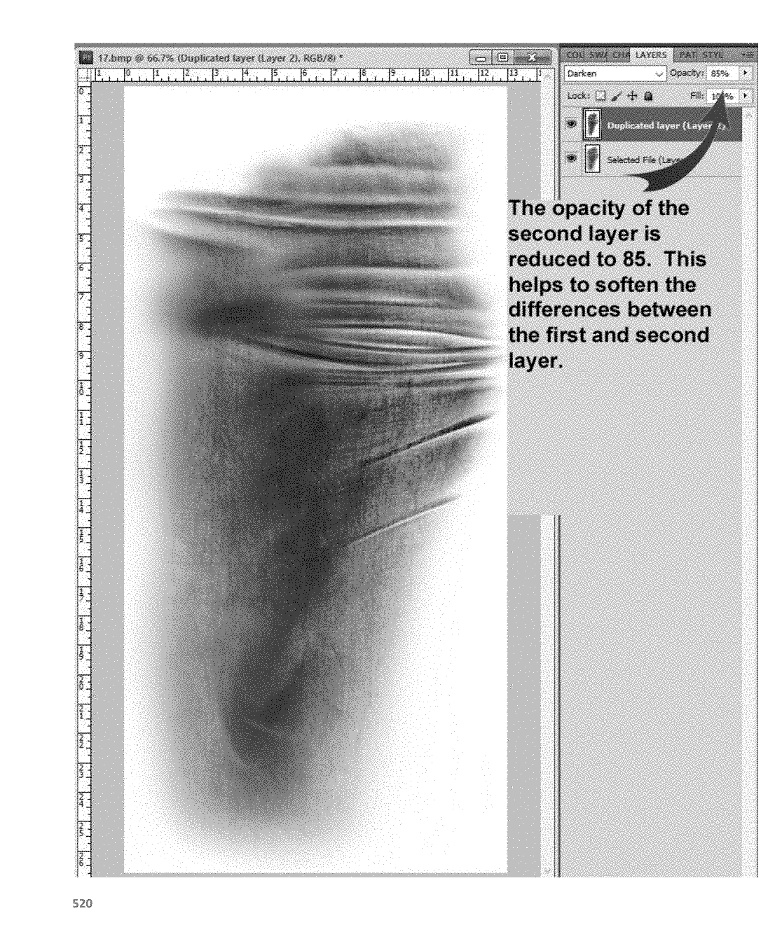

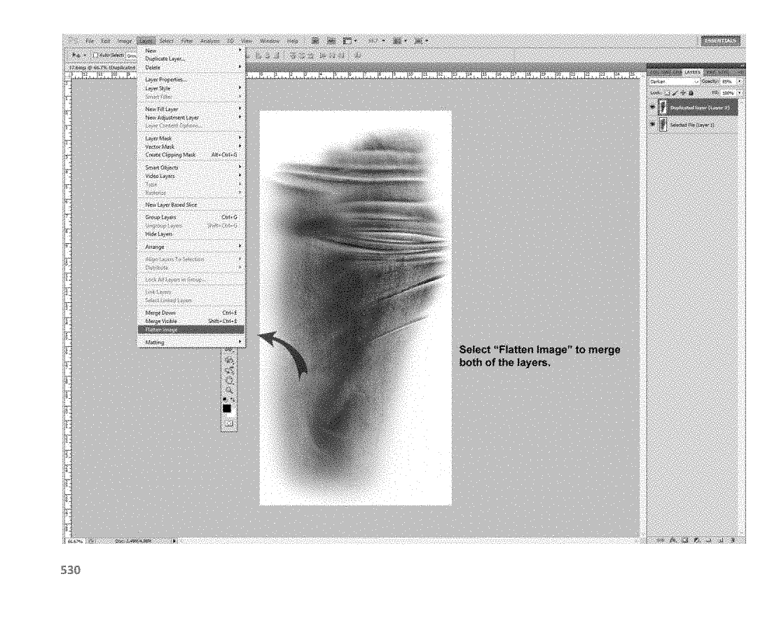

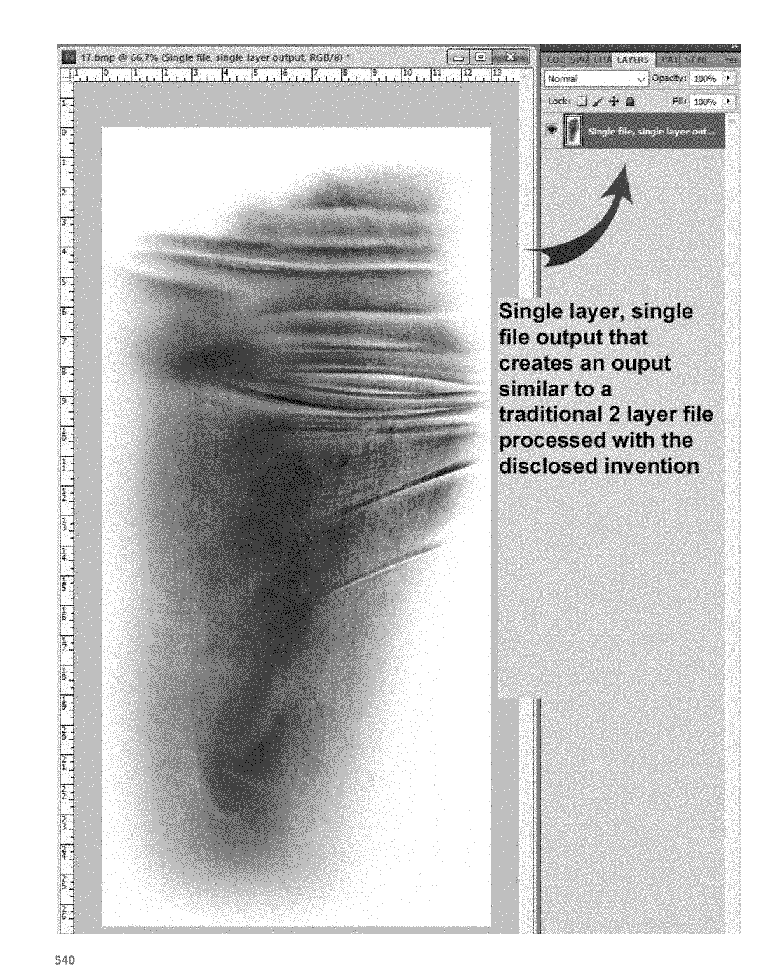

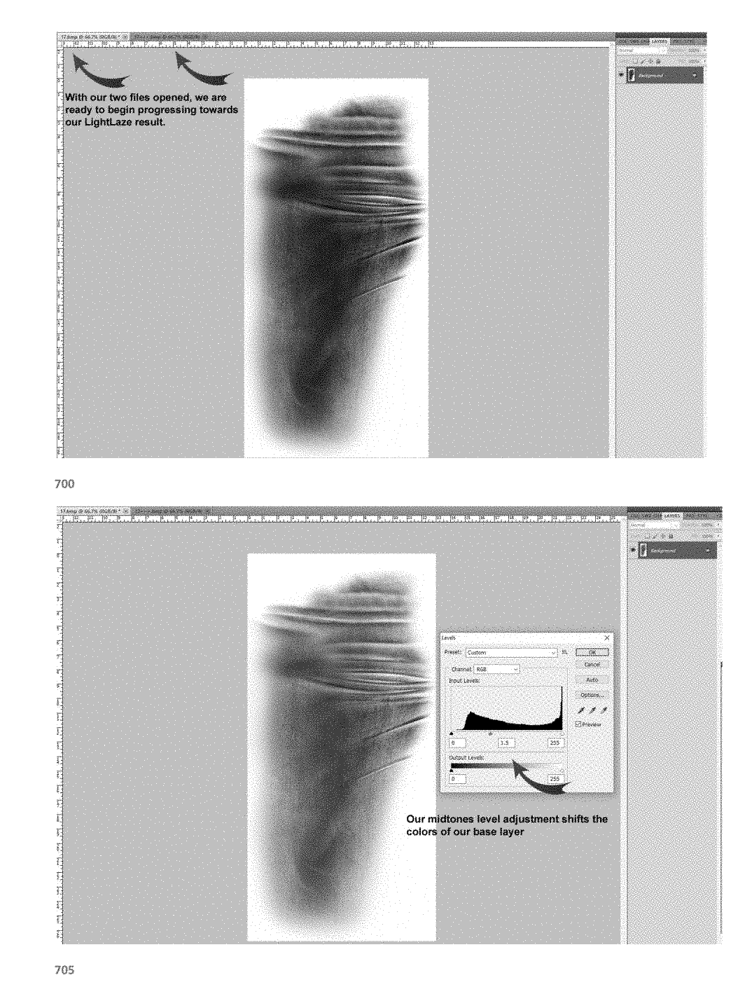

The automation software processes the files in the background and it shows preview Left as original file, Right as Light Version File as shown in FIG. 21.

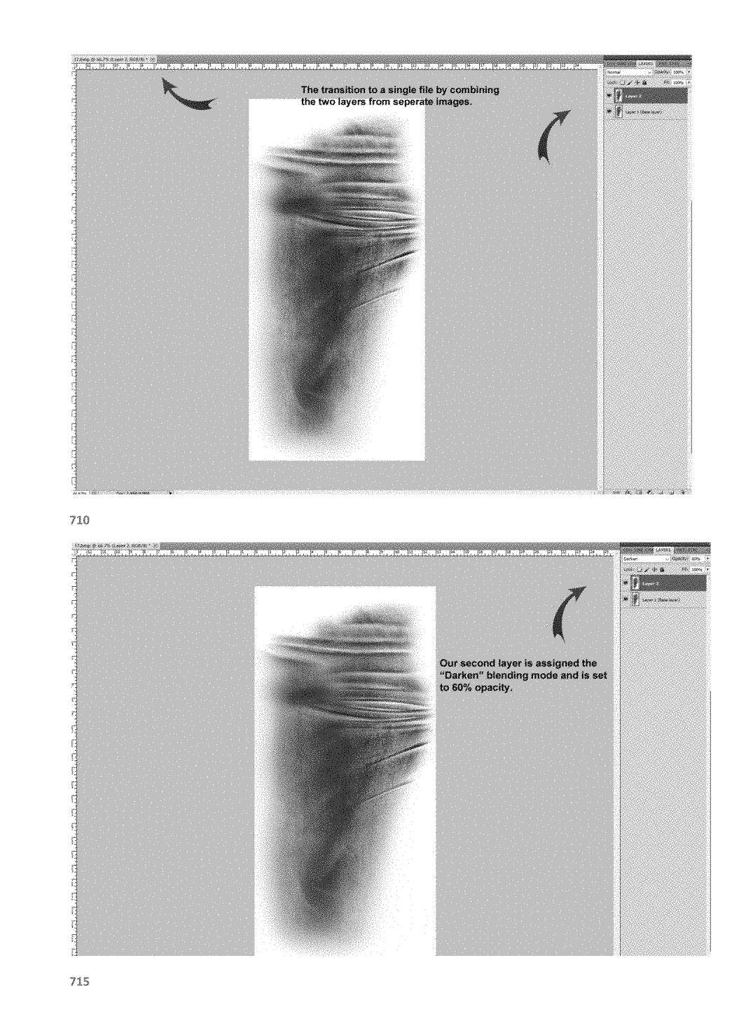

Lastly, the software provides an output File, the Light Version File result in FIG. 22

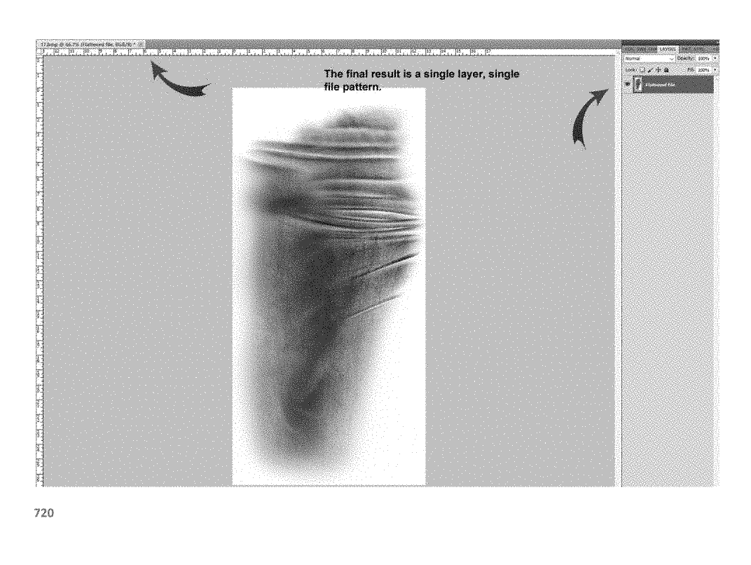

Relative to the dots per inch of the graphic, FIG. 23 shows an example of a file at different dots per inch (DPI).

Some software programs such as Photoshop use the “Dots per inch” or “pixels per inch ” terminology. The more dots or pixels, the richer and more realistic a picture is capable of looking. Increased numbers of doi bring crispness and clarity. Increasing the number of pixels in a given area increase the number of power changes a laser is capable of making in a given area. In the examples above, the differences between 1 DPI through 300 DPI means more definition, sharpness and crispness with more details. Due to the fact that lasers process each row of dots as an individual line, increasing the DPI will increase the number of laser lines in each respective area, consequently increasing the cycle time of an image. There is a minimal DPI required for the laser to process contiguous lines across a substrate, where a lower DPI would result in gaps or stripes of unprocessed areas. There may be a higher DPI value that is an optimal DPI that offers contiguous lines, or slightly overlapping lines, with increased and ideal detail. There is excessive DPI, where the laser processes so many lines within an area that detail begins to get muddied with the excessive overlapping. These DPI values are determined by a combination of factors such as but not limited to beam diameter, and the makeup of the substrate being processed.

When working with beam diameter of 0.5 mm, one would expect the option of getting greater detail and similar line spacing with a DPI nearly double that of a laser processing with a beam diameter of approximately 1 mm. At similar processing speeds, the same 0.5 mm would take nearly twice as long to process a similarly sized image at the doubled DPI due to the near doubling of the rows to be processed. The general usage of DPI range of lasers are 25 to 100 DPI (depending upon the requirement) in the industry with lasers to etch on denim garments. Higher DPI is also used to make damages (torn-out) effect on denim or hole effect depending upon requirement.

With the conventional graphic design methods to create laser abrasion files, the dpi of the laser file was typically around 32-34 and depending upon the laser machine, pixel time of around 45-50 was used. DPI is typically constant where pixel time will change depending upon the type of laser, design, wash and fabric. The dpi or dots per inch is a measure of the resolution of the graphic image. With this novel invention, the dpi of the file can be around 40-42 generating a much higher resolution graphic pattern with more detail. Once again, depending upon the fabric, wash and standard, these values can change. Thus a key embodiment is to increase the dpi by 20% to 60% for graphic patterns created from this invention versus graphic patterns created from standard laser abrasion files. For example, if the grayscale design has darker colors, a DPI range of around 30-50 might produce the right look. If the grayscale design has lighter colors, a DPI range of around 40-60 might produce the right look and these are additional embodiments.

However, to achieve the higher resolution with larger dpi images, the author found that the pixel time must be adjusted. Depending upon the laser machine, pixel time of around 52-60 was used and thought to be ideal in relation to this invention. The novel dpi and pixel time changes are embodiments of this invention. Those skilled in the art would expect some variation in these ranges.

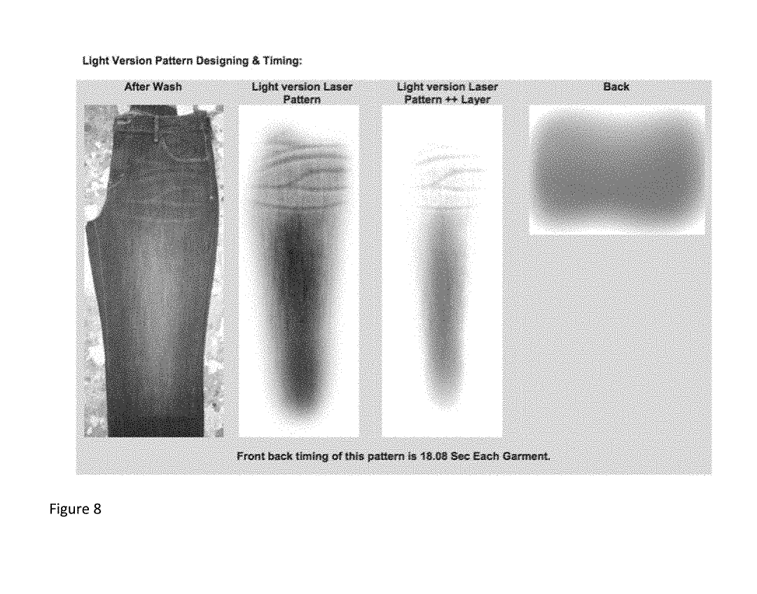

With this novel method, the dpi of the file is around 40-42 and depending upon the laser machine, a pixel time of around 52-60 was used. This is a preferred embodiment and FIG. 8 is an example of this concept. The left side of the picture is how the garment looks when finished after washing and laser treatment. There is no need for hand sanding touch ups or the use of PP spray. The laser design that was created has much lighter colors compared to the normal process and is an embodiment. It was developed in two separate layers to match the standard and highlight the certain parts of the design. There is also a laser design for the back of the garment. That too has much lighter colors compared to the normal process. These novel methods can be drawn as one single layer or it can have multiple layers, which will depend on the standard to be matched and is an embodiment.

An example of a Light Version laser file and laser etching time is shown in FIG. 8.

This dpi and pixel time can vary depending upon how many layers were used in Photoshop to create the look. One layer of the design may have certain grayscale values chosen along with a dpi and pixel time. Another layer may have the same or totally different values. Also, depending upon the fabric, wash and the desired look; dpi, laser intensity or pixel time, and grayscale colors in the design can all be modified. However the inventive concept which reads over the prior art is the same—creating laser files with the high detailed graphic patterns generated by using lighter colors and possibly high dpi and then lasing such patterns.

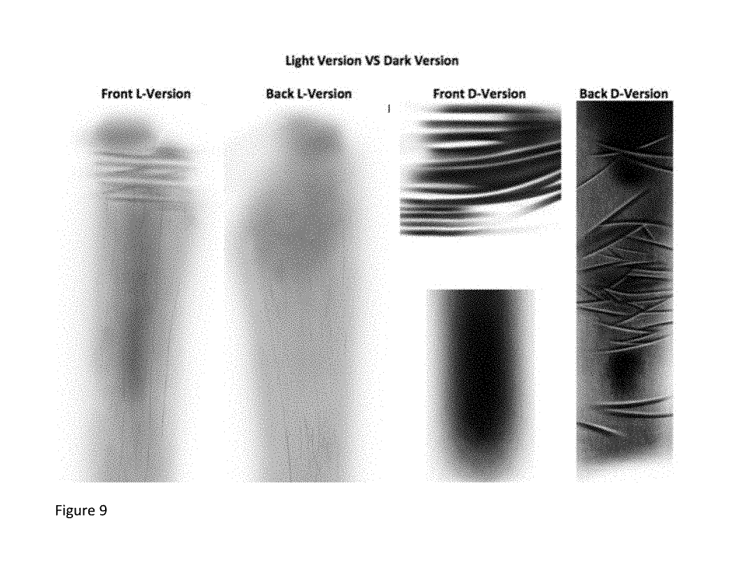

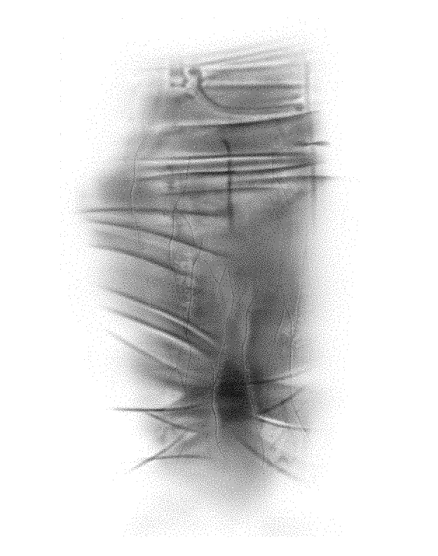

FIG. 9 shows another example of the differences in design from the inventive method compared to the conventional methods of drawing with regard to use of colors in the prior art. The technique the authors invented, Light Version, is shown as L-Version in FIG. 9 and the normal method is called Dark Version or D-Version. The way the Light Version design was created is a preferred embodiment to achieve the optimal results. However, the way the laser design is created, what dpi is used, the chosen intensity or pixel time that determine the overall aesthetic are also embodiments. Those skilled in the art will recognize that some of these parameters can be modified or changed.

One embodiment of the invention is to create these effects at reduced laser cycle time or laser energy intensity. Thus, the invention provides for methods which are less expensive, less energy intensive than the prior art laser abrading and finishing processes, and further results in a garment that has a greater range of pre-wear treatment with even less impact to the garment integrity as a result of this reduction in energy usage. Yet another embodiment of this invention would be to create these effects, perhaps with further improving characteristics such as detail and brightness, through the application of a laser power or laser energy intensity similar to or even higher than that involved with a prewash laser treatment. Inventors believe through experimentation that perhaps there is a difference in maximum laser power or laser energy intensity and an associated realized benefit from that laser power or laser energy intensity. When lasing patterns on a prewashed garment, laser duty cycle may range from 50-75% to achieve a maximum possible brightness with the addition of PP spray. Whereas when lasing patterns on a washed garment, the elimination of starches and much of the indigo allow for less laser energy. For example, a duty cycle ranging from 55-85% for lasing washed garments may remove sufficient amounts of indigo without the requirement for PP spray.

When applying either hand sanding or laser etching on a denim garment, it always takes place on the rigid garment, prior to wet processing as the disclosures cited above reveal for Light Version. In doing so, there has been a misunderstanding that this order of operations has been necessary and is thus commonplace in the industry. The laser processing on rigid (unwashed) garments produces a residue often referred to as ash, which consists of a byproduct of heat interacting with the sizing (varied starches used in denim manufacturing), indigo, and cotton. This residue is resilient and can even often stain the yarns a color unique to both the original white tone of the cotton, and the blue indigo that has been used as a dyeing agent on the cotton. This stain is often a brown, yellow, or even greenish color, and is undesirable and difficult to get rid of. In this process, the hand sanding or laser is tasked with removing sizing and indigo from the state of raw denim (virgin untouched unwashed denim) to the level of targeted brightness for the pre-wear pattern. Also, much of the laser pattern gets absorbed into the fabric and it loses a lot of the detail from the laser pattern file and consequently has a more blurred look. Since the laser etching is always applied on the rigid garment, it may require more laser intensity, which could have a negative effect on the tear and tensile strength of the fabric and may even require more higher power lasers.

So another embodiment of this invention is to use the inventive Light Version laser file methods disclosed above and laser abrade the patterns on washed garments versus rigid garments. This embodiment not only allows for the replacement of hand sanding and/or multiple layer files, but most importantly can replace toxic PP spray as well. The typical procedures for dry processing and wet processing were modified in another embodiment of this invention. The key steps in the normal process consists of the following: 1). Laser etching on the rigid garment, 2). Touching up rigid garment with hand sanding, 3). Washing garment, 4). Applying PP spray, 5). Washing garment again, and finally 6). Drying garment. The inventors discovered a new and improved method with a totally different order of processing along with new inventive techniques. The invention consisted of the following key steps which are embodiments: 1). Wash garment one to three tones darker than standard, 2). Develop laser file as disclosed in the Light Version methods of this invention, 3). Laser etch graphic pattern on washed garment, 3). Run a short wash cycle to remove laser ash and match standard, and finally 4). Dry garment.

An example is provided in Table 1 comparing all the steps in the two different methods. The left side of the table is the normal process used in the denim industry with some 14 steps. The right side of the table are embodiments and represent what the inventor ran in 10 steps that resulted in substantial savings in water, chemical, labor and time and yet more detail in the abrasion pattern. The laser treatment in the second table would include the development of the laser file using methods disclosed in this invention.

Table 1.

Those skilled in the art will understand the steps in the right column can be added to, subtracted and modified. Also, these steps are dependent on a particular washed garment and the abrasion pattern required. Different garments with different wash instructions will show different steps. However, regardless of the steps from the normal process, the invention will generate higher detailed abrasion patterns which allow for the decrease or reduction of hand sanding and PP spray, which are key embodiments of this invention. For example, if it normally takes 2-20 minutes to hand sand touch up a laser treated denim in order to create the authentic worn look, methods of this invention will eliminate the hand sand requirement and thus eliminate or reduce this time. Further, the methods of this invention will provide the abrasion intensity or whiteness achieved with PP spray without ever using the toxic PP spray process. Alternately, the amount of PP spray can be reduced by 50% or more. At the same time, savings in water, chemicals, labor and time can be realized by washing the garment prior to laser etching. Savings of 10-50% were estimated from the experiments and would clearly be a major advancement in the denim industry by not only reducing costs significantly but also markedly improving sustainability and worker conditions. The amount of steps this invention reduces along with the difficulty of the dry and wet processing instructions will play a role in the savings. In some cases, where this technique is replacing very lengthy dry and wet processing instructions, savings of 50% can be possible. The large sustainability improvement comes from the reduction or elimination of the toxic Potassium Permanganate. The marked improvement in worker conditions comes from the reduction or elimination of one of the worst labor jobs in the denim manufacturing factory—hand sanding denim jeans. This new method of treating garments will most likely actually eliminate having to touch up the garment via hand sanding (step #3), eliminate having to apply PP spray (step #10), reduce wash times, and eliminate or reduce other factors involved, which are key embodiments of this invention.

The garment can be tinted as well. Typically, when a garment is tinted, if laser etching occurs on the rigid garment, it will always require hand sand touch ups to match the color cast of the laser etched area and the base cast of the garment. The laser area will not absorb the tint as the hand sanded area. If the whiskers are laser etched and the thigh area is handed sanded, the whiskers will have to be touched up with hand sanding to get the right look. This would require different steps then what was stated above, however, laser treating the garment after wash would still take place. And as a result, there would be significant savings in water, chemical, labor and time. Also, by using the methods in this invention, it would not require any hand sanding touch ups or PP spray. Whatever the steps employed, the laser process will be applied to the washed garment and not the rigid garment as the prior art common practice in the denim industry.

During the laser abrasion process, a large part of the laser energy is expended to remove some or all of the starch or sizing on the rigid denim and some of the indigo dye. Laser etching on the washed denim can require much less energy because the wash process itself reduces the starch or sizing on the fabric and washes down the indigo dye. Experiments with lasers have shown that the laser power or laser energy intensity can be reduced by 20-70% laser etching an abrasion pattern on the washed garment vs the rigid garment for the same end result (achieving same pattern brightness on the finished garment). So, for example, if 500 watt lasers are used to etch abrasion patterns on rigid denim garments, the same patterns with similar intensity may be achieved with 250 watt lasers. Other experiments have shown a reduction in cycle time laser abrading the same pattern on washed garments vs rigid garments by 20-60% with the same end result. However, laser pattern, wash instructions, type of denim fabric, and shade of fabric prior to laser etching will all influence the results and savings.

The laundry conditions (temperature, time, chemistry, etc.) are varied until the wash cycle produces denim that matches the color standard supplied by the manufacturer. The inventors found that one key embodiment was first to wash down the rigid denim less than that required to achieve the standard color tones or characteristics and then to laser etch the pattern. So the denim would be washed down one or several tones darker than that shown in the standard by reducing, water, chemicals or time versus that required for the standard. Then the garment would be laser abraded and washed again lightly so as to match the standard. Yet another embodiment of the invention would be to wash the garment to a color lighter than the target cast before lasing, process the garment with the laser, and then using tint to color both the cast and the laser processed area. The brightness of a tinted laser area relative to the cast that is achievable with this method is otherwise quite difficult to do through conventional methods. A picture of the garment washed and tinted from this invention is shown on the previous page.

A preferred embodiment is to first wash the garment two tones darker than the standard, then laser etch the design. This creative approach allowed the wash to remove the bulk of the starch, sizing and indigo, and tasked the laser to remove only the difference between the target cast (background color) already achieved with the wash, and the targeted tones associated with the pre-wear pattern. This reduction in work required from the laser greatly reduced the ash associated with laser usage, reduced the laser energy required to achieve the targeted abrasion color allowing each system to run as fast as it could safely producing the image required which is yet another embodiment. The inventive method above which reduces the ash is a key embodiment. This concept can apply at any point in the washing process and that is another embodiment. For example, it could apply after desize or it could be washed down to any tone in order to match the standard prior to laser treatment. Further, another embodiment is to completely wash down the garment to match the standard then apply the laser treatment and eliminate the last wash. Another embodiment is to completely wash down the garment to match the standard then apply the laser treatment and then go through a quick wash to remove any ash.

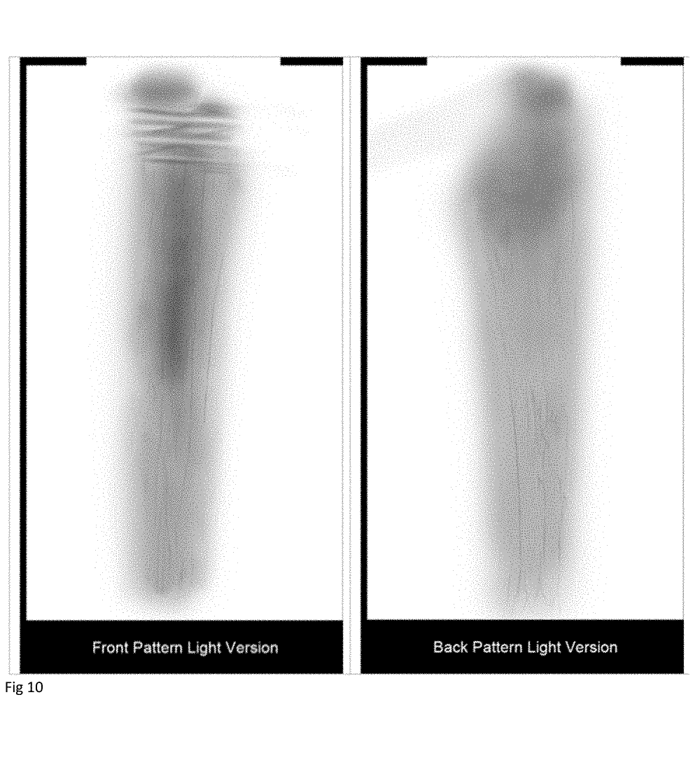

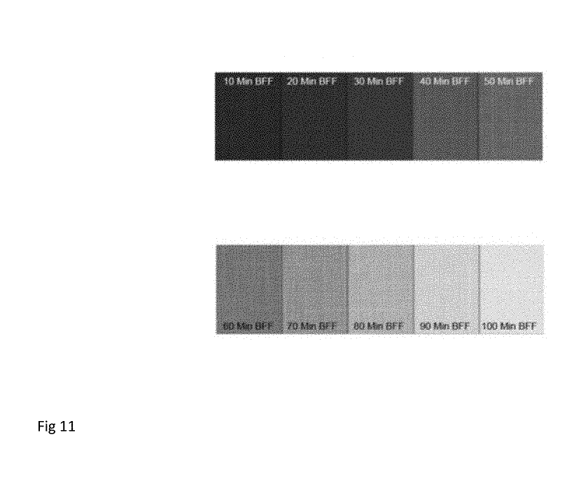

The overall intensity of the design or parameters chosen to achieve the right look will depend upon the standard. FIG. 10 shows different washed down ranges of indigo color for denim, ranging from dark blue to light blue. The top left indigo color only went through a 10 minute wash, while the bottom right indigo color went through a 100 minute wash. Replicating the standard or achieving an acceptable look is what drives the design, but typically, with this invention, the 100 minute indigo color requires a minimum laser intensity to achieve the right look and the 10 minute indigo color requires a much higher laser intensity to achieve a brighter result that still would not require PP spray. One of the benefits of washing the garment two tones darker than the standard or at the standard or as close as possible prior to laser etching, is that the lighter the shade, the less amount of laser intensity is potentially required which represents an embodiment. This can also have benefits in decreased laser cycle times, which can lead to substantial savings in unit costs. FIG. 11 shows the different tones that can be obtained.

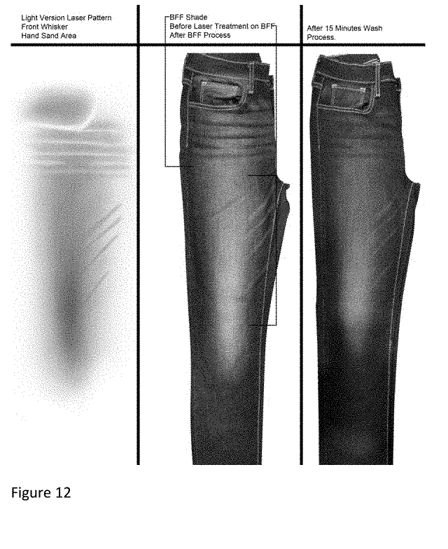

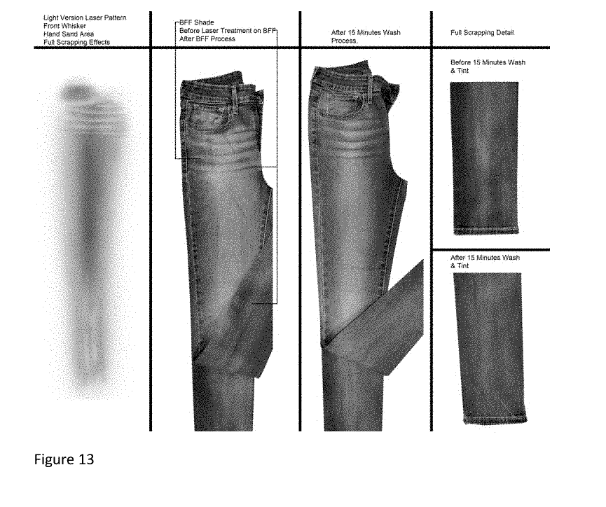

Additionally, by adopting the techniques described in this invention, it is now possible to achieve an entire assortment of new designs and textures. For example, FIG. 12 shows how it is now possible to achieve 3D type looks and optical illusions that appear to have depth which are further embodiments. It is also possible to apply the laser to super stretch fabrics, fabrics that contain sulfur, and fabrics that previously did not react well with the laser because the inventive methods disclosed would require less laser energy intensity which would allow lasing these fabrics which are further embodiments. These techniques can also lead to improvements in tear and tensile strength on the garments because it may require less overall laser intensity compared to the normal process and are embodiments. Also, this concept can apply to patterns as well, such as floral, camouflage, herringbone, etc.

Additional embodiments show how this technique is applied to different finishes, including a dark wash, medium wash and light wash. FIG. 13 below demonstrate these effects.

Random washes or acid washes can be time consuming, costly and require a lot of chemicals. Sometimes washes can take several hours to try and achieve certain looks. They achieve these looks this way, by other labor intensive processes or using expensive denim. By applying these techniques of laser etching on the washed garment, many of these expensive and time consuming processes can be eliminated or greatly reduced.

Not only will methods in this invention lead to higher detailed designs, but more importantly, overall savings in water, chemical, labor and time which the entire denim industry is trying to push in order to be more sustainable.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, this specification refers to determining numbers on a grayscale chart between 0 and 256. However, other levels can be used. For example, the specification refers to color levels between 0 and 255 on a 256 level color grayscale chart. If other level color scales were used, this would refer to a similar percentage of those scales.

Also, the inventors intend that only those claims which use the words “means for” are intended to be interpreted under 35 USC 112, sixth paragraph. Moreover, no limitations from the specification are intended to be read into any claims, unless those limitations are expressly included in the claims.

What is claimed:

Copy from other document

A method(s) substantially as disclosed.

An article substantially as disclosed

What is claimed is:

1. A method of creating a laser abrasion pattern on a computer, comprising: with increased highs and lows by drawing the pattern at increased color levels on a computer, comprising:
obtaining a laser abrasion pattern as a computer file that represents a pattern of abrasion to be lazed on a textile, where larger numbers on a grayscale chart represent lighter colors, and smaller numbers on the grayscale chart represent darker colors to be processed by the laser;
modifying the pattern, to create a darker and more heavily lazed sections of the pattern; and
feathering an abrasion intensity from darker sections to lower intensity sections.

2. The method as in claim 1, wherein the modifying is create color levels ranging between 31% and 47% color gray scale chart, and the feathering uses color levels ranging from 70% to 90% on the color gray scale chart.

3. The method as in claim 2, wherein the color gray scale chart is a 256 level color gray scale chart, and the darker and more heavily lazed sections of the pattern at color levels ranging between 80-120 on the 256 level color gray scale chart, and the feathering the abrasion intensity from the darker sections to lower intensity sections using color levels ranging from 179 to 230 on the 256 level color gray scale chart.

4. The method as in claim 1, wherein the laser abrasion pattern is lightened in an image processing program, by using an image editing tool, from the group consisting of: image editing tools: Levels, Curves, Shadows, Brightness, Exposure, or HDR Toning

5. The method as in claim 1, wherein the obtaining comprises
loading a laser abrasion file into an image editor, and
and where the modifying comprises adding a lightly colored layer to the abrasion file, said layer comprising a value representative of a white, or nearly white file with color values ranging from 90% to 100% of the color grayscale chart, and
selecting said lightly colored layer and choosing an available blending mode and an appropriate opacity that lightens the original file.

6. The method as in claim 1, wherein the computer file is a single layer laser abrasion file:
wherein the obtaining comprises opening the single layer laser file in an image processing computer program, and
and the modifying comprises duplicating a background layer of the single layer laser file,
selecting a first layer, and setting a level associated with white tones from its default 100% to a value between 59% to 75%, and
selecting a second Layer and adjusting midtones from default 1.00 to a value between 1.20 to 1.80, and
after setting the level of the first layer and midtones of the second layer, merging the first and second layers into a combined processed image, and
setting Opacity of the combined processed image from a value between 60-90%, and
saving the image as Light Version Output laser abrasion file; and
using the Light Version Output laser abrasion file to drive a laser to process a textile.

7. The method as in claim 6 wherein the blending mode algorithm determines the tones of multiple layers being blended can include Darken, Multiply, Color Burn, Linear Burn, Screen, overlay, Softlight, Hardlight, Vividlight, Pinlight, Darker Color, Hard Mix, or Luminosity.

8. The method as in claim 6 wherein the modifying is carried out through a software program that automatically employs the steps without user control.

9. The method as in claim 1, wherein the laser abrasion pattern includes first and second laser abrasion files to be converted into one Light Version laser abrasion file, and the modifying comprises:
opening first and second laser abrasion files In an image processing program, and
adjusting a midtones input level of the first file from 1.00 to value between 1.20 to 1.80 of the first file, and
pasting the second file over the copy of the first file, and
select pasted layer type, and
select any blending mode algorithms determining the tones of multiple layers being blended, and
select first layer opacity value between 40-80%, and
saving the Light Version laser abrasion file and using the Light Version Output laser abrasion file to drive a laser to process a textile.

10. A method to laser abrade Light Version files as in claim 9 wherein the laser processing of the files occurs at power levels from 250-2,500 watts.

11. A method to replicate the look of multi layer laser abrasion files comprising the steps of;
obtaining a laser abrasion computer file representing a textile effect to be replicated,
copying the laser abrasion file,
darkening colors in specific areas of the copied file that require increased abrasion, including at least whiskers and a knee area to create a modified copy, and
superimposing the modified copy on top of the original file, and
combining the files into one Light Version file; and
using the Light Version Output laser abrasion file to drive a laser to process a denim garment.

12. A method as in claim 1, wherein the modifying and the feathering comprises creating a first pattern by:
using color levels on a 256 level color grayscale chart from 31% to 46% for the most intense sections of the graphic and 78% to 86% for the least intense sections of the graphic, and creating a second pattern by:
duplicating the first pattern,
selectively decreasing color values on the second, duplicated pattern in selected areas such as whiskers and the knee, and
pasting the second pattern on the first pattern as an additional layer and
converting to a Light Version file for laser abrading, and
Using the light version file to Laser abrade the file on denim garments.

13. The method of claim 12 further comprising enhancing the pattern by adjusting a shadow input level range between 20-40 and a mid-tone value range between 1.5 and 2.5

14. A computer apparatus for creating a laser abrasion pattern with increased highs and lows by drawing the pattern at increased color levels on a computer, comprising:
a computer system, processing a computer file indicative of a laser abrasion pattern that represents a pattern of abrasion to be lazed on a textile, where larger numbers on a grayscale chart represent lighter colors, and smaller numbers on the grayscale chart represent darker colors to be processed by the laser;
the computer operating for modifying the pattern, to create a darker and more heavily lazed sections of the pattern; and for feathering an abrasion intensity from darker sections to lower intensity sections.

15. The computer apparatus as in claim 14, wherein the computer system creates color levels ranging between 31% and 47% color gray scale chart, and the feathering uses color levels ranging from 70% to 90% on the color gray scale chart.

16. The computer apparatus as in claim 14, wherein the computer system, wherein the color gray scale chart is a 256 level color gray scale chart, and the darker and more heavily lazed sections of the pattern at color levels ranging between 80-120 on the 256 level color gray scale chart, and
the feathering the abrasion intensity from the darker sections to lower intensity sections using color levels ranging from 179 to 230 on the 256 level color gray scale chart.

17. The computer apparatus as in claim 14, wherein the laser abrasion file is loaded into an image editor, and
and where the computer carries out the modifying by adding a lightly colored layer to the abrasion file, said layer comprising a value representative of a white, or nearly white file with color values ranging from 90% to 100% of the color grayscale chart.

18. The computer apparatus as in claim 14, wherein the computer file is a single layer laser abrasion file:
wherein the single layer laser file is opened in an image processing computer program, and
and the modifying comprises duplicating a background layer of the single layer laser file,
and the computer selects a first layer, and sets a level associated with white tones from its default 100% to a value between 59% to 75%, and
and the computer selects a second Layer and adjusts midtones from default 1.00 to a value between 1.20 to 1.80, and
and the computer operates, after setting the level of the first layer and midtones of the second layer, merging the first and second layers into a combined processed image, and
and that computer operates for setting Opacity of the combined processed image from a value between 60-90%, and
and the computer operates for saving the image as Light Version Output laser abrasion file; and
using the Light Version Output laser abrasion file to drive a laser to process a textile.

19. The computer apparatus as in claim 14, wherein the laser abrasion pattern includes first and second laser abrasion files to be converted into one Light Version laser abrasion file, and the computer operates to:
open first and second laser abrasion files In an image processing program, and
adjust a midtones input level of the first file from 1.00 to value between 1.20 to 1.80 of the first file, and
pastie the second file over the copy of the first file, and
select pasted layer type, and
select any blending mode algorithms determining the tones of multiple layers being blended, and
select first layer opacity value between 40-80%, and
saving the Light Version laser abrasion file and usie the Light Version Output laser abrasion file to drive a laser to process a textile.
